(19) United States
(12) Patent Application Publication
(10) Pub. No.: US 2025/0345805 A1
(43) Pub. Date: Nov. 13, 2025

(54) COMPOSITIONS AND METHODS FOR FROTH FLOTATION OF MINERAL ORES

(71) Applicant: Ecolab USA Inc., St. Paul, MN (US)

(72) Inventors: Yu Xiong, Charlotte, NC (US); Jannice Kooi Poh Kubinski, Glen Ellyn, IL (US); Xiaodong Huang, Aurora, IL (US)

(21) Appl. No.: 19/204,969

(22) Filed: May 12, 2025

Related U.S. Application Data
(60) Provisional application No. 63/646,029, filed on May 13, 2024.
(60) Provisional application No. 63/795,922, filed on Apr. 28, 2025.

(51) Int. Cl. B03B 1/04; B03D 1/02

(52) U.S. Cl. CPC B03B 1/04; B03D 1/021

(57) ABSTRACT

Improved partitioning compositions for froth flotation of mineral ores, and improved methods of froth flotation using the partitioning compositions have been developed. The partitioning compositions are suitably added to a mineral ore slurry in a single addition to provide a sparge composition that is ready for sparging. The use of the partitioning compositions obviates the need to adjust the pH of the ore slurry before or after the addition, and further avoids the use of compounds having a flashpoint of 60° C. or less. Meanwhile, the partitioning compositions obtain improved grade and recovery of phosphate product (P₂O₅) in froth flotation of phosphate ores, when compared to conventional chemistry and methods used for froth flotation of a phosphate ores.

### BACKGROUND

Many minerals and other materials are obtained from mining and other resource recovery operations as an intimate mixture that is difficult to separate into its constituents. For example, ores as mined are often multimineralic, and contain at least one desired component, a beneficiary, and one or more other less valuable and/or desirable materials, a gangue.

In a beneficiation process, two or more materials that coexist in a mixture are separated from each other to obtain a beneficiary in a more concentrated form than that which existed in the mixture. One form of beneficiation is froth flotation separation. In froth flotation separation of a mineral ore, the ore is finely ground (comminuted) to form a comminuted ore in the form of a particulate. The comminuted ore is slurried in a liquid medium, typically water, to make a slurry that is a sparge composition. Other components that assist in the separation of beneficiary from gangue can be included in the sparge composition, components such as collectors, modifiers, depressants, frothers (frothing agents), and/or activators.

In a process known as sparging, a gas, typically air, is bubbled through the sparge composition, and a froth forms at the surface of the sparge composition. During sparging, some materials from the ore such as targeted particles are carried up with the gas bubbles (i.e. floated) and concentrate in the froth, whereas other materials concentrate in the body of the liquid, the underflow.

Two common forms of flotation separation processes are direct flotation and reverse flotation. In direct flotation processes the froth comprises the beneficiary or concentrate, while in reverse flotation processes the froth comprises gangue or tailings. The object of the flotation in both forms of froth flotation is to separate and recover as much as possible of the beneficiary from the particulate material in as high a concentration of that beneficiary as possible. To carry out froth flotation, a sparge composition is sparged to form a froth layer and an underflow. In a direct froth flotation, the froth layer comprises a concentrated beneficiary (a concentrate), and the underflow comprises tailings (a gangue). That is, the froth can comprise more beneficiary than gangue, and the tailings can comprise more gangue than beneficiary.

A prerequisite for flotation separation is the liberation of particles. For flotation partitioning of mineral ores, comminuting (grinding the solids up by such techniques as dry-grinding, wet-grinding, milling, and the like) is required to liberate minerals. Extensive grinding or comminution can result in better liberation of particles for the separation of beneficiary and gangue in a froth flotation process.

The comminuted ore is then mixed with an aqueous medium, such as water, and several different chemicals are added to the resulting slurry that are designed to increase partitioning of the beneficiary from the gangue when the slurry is sparged—that is, when bubbles are introduced into the slurry—to form a sparge composition (ore slurry ready for sparging). In direct froth flotation, one or more chemicals may be added to an ore slurry in order to accomplish one or more of: encouraging formation of a robust froth that does not collapse and is capable of holding an amount of beneficiary particles trapped therein (“frother”); increasing hydrophobicity of bubble surfaces and/or beneficiary particle surfaces to maximize adsorption of the beneficiary particles to the bubble surfaces (“collector”), sometimes in a mixture with one or more other chemicals to further increase the efficiency or boost performance of the collector (“modifier”); increasing the hydrophilicity of gangue particle surfaces to minimize adsorption thereof to the bubble surfaces (“depressant”); or modifying another reagent in situ to result in a form that obtains the benefit of a collector, modifier, frother, or depressant (“activator”).

Conventionally, collectors, frothers, modifiers, and depressants are added to an ore slurry to form a sparge composition, which is an ore slurry ready to be sparged and partitioned in a batch type process. The addition of chemicals to the ore slurry is conventionally carried out in at least two separate steps, and often three or more steps. For example, a collector/modifier may be added to an ore slurry in a separate step from addition of the frother, and a depressant may be added in yet another separate step from the collector/modifier and the frother. Activators are added in a separate step from the chemical they are intended to activate, often due to imcompatibility or solubility issues with an activated form of chemical. Additionally, it is often necessary to adjust the pH of an ore slurry as part of optimizing the interaction of the chemicals with the beneficiary, the bubbles, or the gangue. Adding a pH adjustment agent to the ore slurry is yet another separate step in the froth flotation process. Often, pH of an ore slurry is adjusted prior to adding other chemicals to the ore slurry to form the partition.

In addition to the foregoing multiple additions, in many conventional froth flotation processes it is necessary to add one chemical, for example a collector, and allow it to fully adsorb to all available beneficiary particle surfaces before adding a different chemical, such as a depressant or a frother to the system in order to achieve optimal partitioning during sparging. Accordingly in many cases, it is necessary industrially to “condition” the ore slurry between chemical additions—that is, allow a period of stirring between chemical additions-thereby extending the amount of time required to partition each batch of ore slurry. Like the order of chemical additions to the ore slurry, the amount of time between such additions is optimized and carefully controlled to obtain the highest efficiency of the separation and yield/purity of the beneficiary.

Finally, in many froth flotation processes, it is necessary to use petroleum chemicals having a low flashpoint, that is, a flashpoint of less than 60° C. as a component of froth flotation (often as a modifier). The flash point of a material is defined as the lowest temperature at which a liquid gives off vapors that can be ignited; the US Construction Safety Act codifies the definition of a flammable liquid at 29 CFR 1926 in part as any liquid having a flash point below 60° C. The flash point of the petroleum fluids used in froth flotation is often significantly lower than 60° C.: for example, diesel fuel, commonly used as a modifier for fatty acid collectors in direct flotation of phosphate ores, has a flash point of about 52° C. Other petroleum or biofuel sources used as modifiers include fuel oil (various grades) and biodiesel. Fuel oil includes alkanes, cycloalkanes, and aromatic compounds in the range of C15 to C30.

The hazards of large-scale froth flotation employing low flash point petroleum compounds and mixtures thereof are well understood by those of ordinary skill to include the potential for fire and concomitant equipment damage and injury to operators. Further, the need to use low flash point liquids necessitates employers to provide adequate safety measures related to both flammability and potential VOC exposure of operators, and comply with a patchwork of global regulatory structures governing their use.

Accordingly, there is an ongoing need in the froth flotation industry to provide improved compositions and methods of froth flotation that can be implemented in existing froth flotation installations for separation of beneficiaries from ores. It would be an advantage to increase the efficiency and simplicity of the froth flotation process by reducing the number of separate chemical additions to an ore slurry that are required to prepare the ore slurry for froth flotation. It would be an advantage to provide improved methods and materials for obtaining better yields and better purity of beneficiaries. In accomplishing any of the foregoing, it would be an advantage to avoid the use of chemical additives for froth flotation that have a flash point of less than 60° C.

### SUMMARY

Disclosed in first embodiments herein are partitioning compositions comprising, consisting essentially of, or consisting of a mixture of:
one or more alkoxylated fatty alcohols,
one or more triglycerides,
one or more fatty acids,
one or more fatty acid salts,
a C11 to C24 hydrotreated petroleum distillate, and
water.

The partitioning compositions exclude a base: that is, forming the partitioning composition excludes combining a compound such as sodium hydroxide, potassium hydroxide, sodium carbonate (soda ash) with one or more alkoxylated fatty alcohols, one or more triglycerides, one or more fatty acids, one or more fatty acid salts, C11-C24 hydrotreated petroleum distillate, water, or any combination thereof.

In any one or more partitioning compositions of first embodiments, the one or more alkoxylated fatty alcohols are “actives” therein, and are present in the partitioning composition in a total amount of about 1 wt % to about 10 wt %. In any one or more partitioning compositions of first embodiments, one or more of the alkoxylated fatty alcohols has a structure according to the formula

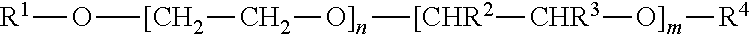

wherein
   R¹ is a linear, branched, or alicyclic C6-C30 saturated or unsaturated moiety,
   R² and R³ are independently selected from H or a C₁-C₅ linear or branched alkyl moiety,
   R⁴ is H or CH₃, and
   m and n are independently selected to be an integer between 5 and 50.

In any one or more partitioning compositions of first embodiments, the one or more alkoxylated fatty alcohols comprises, consists essentially of, or consists of a first alkoxylated fatty alcohol comprising R¹ that is a linear or branched C16-C18 moiety; and a second alkoxylated fatty alcohol comprising R¹ that is a linear or branched C11-C14 moiety. In embodiments, the weight proportion of the first alkoxylated fatty alcohol to the second alkoxylated fatty alcohol in the partitioning composition is 3:1 to 1:3.

In any one or more partitioning compositions of first embodiments, the one or more triglycerides are “actives” therein, and are present in the partitioning composition in a total amount of about 3 wt % to about 10 wt % based on the weight of the composition. In any one or more partitioning compositions of first embodiments, the one or more triglycerides independently has a structure according to the formula

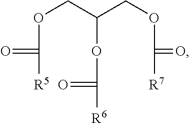

wherein R⁵, R⁶, and R⁷ are independently selected from saturated or unsaturated C16-C30 linear, branched, or alicyclic moieties. Accordingly, the one or more triglycerides are fatty acid triglycerides. In any one or more partitioning compositions of first embodiments, one or more of R⁵, R⁶, and R⁷ are C16-C20 moieties. In any one or more modifier compositions of first embodiments, at least one of the one or more triglycerides is derived from a plant source. Suitable plant sources include whole plants, seeds, stems, flowers, roots, or two or more thereof from cotton, flax, grape, hemp, safflower, olive, palm, peanut, rice, avocado, canola, coconut, corn, sesame, soybean, sunflower, walnut, or any combination thereof.

In any one or more partitioning compositions of first embodiments, the one or more fatty acids are “actives” therein, and are present in the partitioning composition in a total amount of about 55 wt % to about 65 wt % based on the weight of the composition. In any one or more partitioning compositions of first embodiments, the one or more fatty acids are independently selected from natural mixtures thereof, such as soy fatty acids or tall oil fatty acids, as well as fatty acid species such as stearic acid, palmitic acid, oleic acid, linoleic acid, linolenic acid, palmitoleic acid, 11-eicosenoic acid, erucic acid, and nervonic acid, or any combination thereof.

In any one or more partitioning compositions of first embodiments, the one or more fatty acid salts are “actives” therein, and are present in the partitioning composition in a total amount of about 10 wt % to about 20 wt % based on the weight of the composition. In any one or more partitioning compositions of first embodiments, the one or more fatty acid salts are independently selected from sodium, lithium, potassium, or ammonium salts of the conjugate bases of any of the fatty acids listed above, as well as the sodium, lithium, potassium, or ammonium salts of the conjugate bases of hydroxyacids such as ricinoleic acid, 12-hydroxystearic acid, 9,10-dihydroxyoctadecanoic acid, 9,10,18-trihydroxyoctadecanoic acid, lesquerolic acid, 15-hydroxyhexadecanoic acid, isoricinoleic acid, densipolic acid, 14-hydroxy-eicosa-cis-11-cis-17-dienoic acid, 2-hydroxyoleic acid, 2-hydroxylinoleic acid, 18-hydroxystearic acid, 18-hydroxylinoleic acid, and 15-hydroxylinoleic acid.

In any one or more partitioning compositions of first embodiments, the C11-C24 hydrotreated petroleum distillate, which is assigned CAS No. 64742-47-8, is an “active” therein, and is present in the partitioning composition in a total amount of about 1 wt % to about 5 wt % based on the weight of the composition. The C11-C24 hydrotreated petroleum distillate has a flash point of 115° C. or greater.

In any one or more partitioning compositions of first embodiments, the partitioning composition further includes water, which functions as a solvent in the composition and is not considered an “active” component thereof. In any one or more partitioning compositions of first embodiments, water is present in an amount of about 10 wt % to about 20 wt %. In some such embodiments, the partitioning composition including about 10 wt % to about 20 wt % water is termed a “concentrate”. In some second embodiments, a partitioning composition concentrate is diluted by mixing an additional amount of water with the concentrate to form a dilute partitioning composition including 25 wt % to 99.9 wt % water, wherein the balance is the partitioning composition actives.

Disclosed in second embodiments herein are sparge compositions comprising, consisting essentially of, or consisting of a mixture of: a medium comprising water; a mineral ore comprising a beneficiary and a gangue; and a partitioning composition of any of first embodiments herein. In any one or more sparge compositions of second embodiments, the medium comprising water is fresh water or sea water. In any one or more sparge compositions of second embodiments, the mineral ore is a phosphate ore. In any one or more sparge compositions of second embodiments, the partitioning composition is present in the sparge composition in an amount of about 0.01 kg to about 10 kg per metric ton of mineral ore in the sparge composition.

Disclosed in third embodiments herein are methods of froth flotation comprising, consisting essentially of, or consisting of combining a medium comprising water with a mineral ore comprising a beneficiary and a gangue to form an ore slurry; adding a partitioning composition of any of first embodiments to the ore slurry to form a sparge composition of second embodiments; and sparging the sparge composition to yield a sparged composition. The sparged composition comprises an overflow (froth) and an underflow. In any one or more methods of third embodiments, the method further includes collecting the overflow, collecting the underflow, or collecting both the overflow and the underflow.

In any one or more third embodiments herein, the methods consist essentially of or consist of two liquid/solid combining steps: first, combining the mineral ore and the medium comprising water to form the ore slurry; second, adding the partitioning composition to the ore slurry to form the sparge composition. Then air or another gas is bubbled through the sparge composition (sparging) to form a sparged composition, and an overflow and/or an underflow may be collected from the sparged composition.

In any one or more methods of third embodiments, the partitioning composition is added to an ore slurry as a concentrate, that is, a composition having about 80 wt % to about 90 wt % actives. In any one or more methods of third embodiments, the partitioning composition is diluted to form a diluted partitioning composition of first embodiments herein, and the dilute partitioning composition is added to an ore slurry. In some methods of third embodiments, adding the partitioning composition to the ore slurry comprises, consists essentially of, or consists of diluting the partitioning composition with an additional amount of water to form a dilute partitioning composition having 0.1 wt % to 75 wt % actives, and adding the dilute partitioning composition to an ore slurry.

Disclosed in fourth embodiments herein are uses of any one or more of the partitioning compositions of first embodiments, to obtain a sparge composition of second embodiments herein using only two liquid/solid combining steps.

In any one or more fourth embodiments herein, the froth flotation method is simplified in terms of the number of liquid/solid combining steps, compared to the number of liquid/solid combining steps required to carry out a conventional froth flotation procedure. In addition to the simplified procedure, which does not even require pH adjustment of the ore slurry, the use of the methods and partition compositions described herein obtain improved recovery (yield) of phosphate product (beneficiary) when compared to conventional froth flotation methods and chemistries.

### DETAILED DESCRIPTION

Although the present disclosure provides references to preferred embodiments, persons skilled in the art will recognize that changes may be made in form and detail without departing from the spirit and scope of the invention. Reference to various embodiments does not limit the scope of the claims attached hereto. Additionally, any examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control.

As used herein, the terms “comprise(s),” “include(s),” “having,” “has,” “can,” “contain(s),” and variants thereof are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” or “about 1 to about 5”, the recitation means “1 to 5” and “about 1 to about 5” and “1 to about 5” and “about 1 to 5” unless specifically limited by context.

As used herein, “ore” or “mineral ore” means a solid material of economic value that is obtained from a subterranean source by excavation, and also the refined or processed products of such solids. Excavation includes but is not limited to quarrying, open-cast mining, or pit mining. Ores include but are not limited to rocks, minerals, mineral aggregates, metal compounds including both elemental forms of metal and compounds including metal atoms, and any rank of coal (peat, lignite, sub-bituminous, bituminous, or anthracite).

As used herein, “beneficiary” refers to the one or more economically valuable products present in a mineral ore as-mined, and also as separated from a mineral ore by refining and/or processing. Accordingly, “beneficiary” herein refers to the mineral(s) present in a mineral ore that are partitioned from a gangue, or are desirably partitioned from a gangue using froth flotation; and are desirably further collected for further purification, thermochemical conversion, or some other process to enable its economic value to be exploited.

As used herein, “gangue” refers generally to materials of low or no commercial value that are present in a mineral ore as-mined, for example clay or feldspar; and also as separated from a beneficiary by refining and/or processing of a mineral ore, and also the materials of low or no commercial value desirably partitioned from the beneficiary in order to increase the yield and/or purity of the beneficiary that is collected. Accordingly, “gangue” refers to the one or more materials present in a mineral ore as-mined, that are partitioned from the beneficiary, or are desirably partitioned from the beneficiary using froth flotation.

As used herein, “comminute” means to mechanically reduce the size of a solid mass. Non-limiting examples of comminuting include pulverizing, milling, crushing, and grinding.

As used herein, “flotation” or “froth flotation” indicates a process in which a sparge composition is sparged to form a sparged composition, wherein the sparged composition includes an overflow and an underflow.

As used herein, “overflow” refers to the froth portion of a partitioned sparged composition, wherein “froth” refers to a plurality of bubbles present in a sparged composition during sparging, after sparging, or both during and after sparging and collected at or proximal to the liquid-gas interface. The bubbles are formed by sparging the sparge composition with a gas such as air.

As used herein, “underflow” refers to the non-froth portion of a partitioned sparged composition; and accordingly an underflow excludes or substantially excludes froth.

As used herein, “salt” refers to the conjugate base of an organic acid moiety, such as a carboxylate (conjugate base of a carboxylic acid), unless otherwise specified or indicated by context herein. The term “salt” refers not only to full salts but also to half-salts and the like, further as specified or determined by context herein. In embodiments, the salts comprise counterions, or cations, selected from Na⁺, Li⁺, K⁺, NH₄⁺, Ca⁺², Zn⁺², Mg⁺², and combinations thereof.

As used herein, “active” in reference to a component of a partitioning composition or a sparge composition means a component that is operable to affect partitioning of a beneficiary from a gangue in a froth flotation, that is, a compound that is operable during and after sparging of a sparge composition to affect partitioning in the resulting sparged composition.

### DISCUSSION

Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

We have identified certain compositions, referred to herein as partitioning compositions, that obtain direct froth flotation of mineral ores by addition thereof to an ore slurry, followed by sparging. The methods of froth flotation enabled by the use of the partitioning compositions thereby obtain an ore slurry ready for sparging—that is, a sparge composition-upon a single addition of a partitioning composition to an aqueous ore slurry. We have found that such use of the partitioning compositions obviates the need to adjust the pH of the ore slurry prior to the addition. Further, no other collectors, modifiers, frothers, depressants, or activators are added in separate steps to the ore slurry to obtain a sparge composition. Accordingly, the sparge compositions described herein can comprise an ore, an aqueous medium, and a partitioning composition; and advantageously consist essentially of or even consist of an ore, an aqueous medium, and a partitioning composition as described herein. The methods of froth flotation enabled by the use of the partitioning compositions are thus greatly simplified over conventional methods of froth flotation, which involve at least two steps to form a sparge composition (ore slurry ready for sparging) from an ore slurry (combination of ore and aqueous medium), and often more than two steps. Using the partitioning compositions described herein, a single solid/liquid addition to an ore slurry obtains a sparge composition therefrom. That is, a single addition of a partitioning composition as described herein to an ore slurry obtains a sparge composition.

In many conventional froth flotation processes, pH of the ore slurry must be adjusted to a prescribed range prior to adding other liquids and solids to the ore slurry in preparation for sparging. Further, addition of collector/modifier to the ore slurry is often separate from addition of depressants and frothers, due to incompatibility of these components and/or the need to apply certain chemicals to initially contact one or more particle surfaces prior to additional chemicals being added to the aqueous ore slurry environment. Accordingly, conditioning (period of stirring between solid/liquid additions) is often required between addition of depressant/frother and collector/modifier to an ore slurry in preparation for sparging. In some cases, collector and modifier compounds are also added in separate steps to an ore slurry in order to obtain optimal performance—that is, yield and recovery of the beneficiary.

In addition to the simplicity of the methods described herein, the instant partitioning compositions negate the need to adjust pH of an ore slurry prior to or after addition of the partitioning composition to the ore slurry, as is conventionally required in froth flotation processes. In the embodiments below, the partitioning compositions are formulated for use in froth flotation of phosphate ores, and exemplify the direct flotation of phosphate ore without pH adjustment. Other partitioning compositions, formulated to address other types of ores (such as copper/molybdenum, gold, silver, iron, bitumen, or coal for example) may similarly benefit from the approach described herein to negate a currently required pH adjustment step prior to addition of the partitioning composition thereto.

### First Embodiments

In any one or more first embodiments herein, a partitioning composition comprises, consists essentially of, or consists of a mixture of:
one or more alkoxylated fatty alcohols,
one or more triglycerides,
one or more fatty acids,
one or more fatty acid salts,
a C11-C24 hydrotreated petroleum distillate, and
water.

In any one or more partitioning compositions of first embodiments, the one or more alkoxylated fatty alcohols are “actives” therein, and are present in the partitioning composition in a total amount of about 1 wt % to about 10 wt % based on the amount of the partitioning composition, for example 1 wt % to 2 wt %, 2 wt % to 3 wt %, 3 wt % to 4 wt %, 4 wt % to 5 wt %, 5 wt % to 6 wt %, 6 wt % to 7 wt %, 7 wt % to 8 wt %, 8 wt % to 9 wt %, or 9 wt % to 10 wt %. In any one or more partitioning compositions of first embodiments, one or more of the alkoxylated fatty alcohols has a structure according to the formula (1)

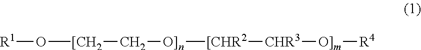

wherein
   R¹ is a linear, branched, or alicyclic C6-C30 saturated or unsaturated moiety,
   R² and R³ are independently selected from H or a C₁-C₅ linear or branched alkyl moiety,
   R⁴ is H or CH₃, and
   m and n are independently selected to be an integer between 5 and 50.

In any one or more first embodiments herein, in the alkoxylated fatty alcohol of formula (1), R¹ includes 6-30 carbons, for example 8-30 carbons, 10-30 carbons, 10-26 carbons, 10-22 carbons, 6-20 carbons, 8-20 carbons, or 10-20 carbons. In any one or more embodiments of the alkoxylated fatty alcohol of formula (1), R¹ is linear. In any one or more embodiments of the alkoxylated fatty alcohol of formula (1), R¹ is branched. In any one or more embodiments of the alkoxylated fatty alcohol of formula (1), R¹ includes one or more unsaturated moieties. In any one or more embodiments of the alkoxylated fatty alcohol of formula (1), R² is H; and R³ is CH₃. In any one or more embodiments of the alkoxylated fatty alcohol of formula (1), n and m are independently selected to be 5, 6, 7, 8, 9, 10, 11, 12, 13, 14, 15 16, 17, 18, 19, 20, 21, 22, 23, 24, 25, 26, 27, 28, 29, 30, 31, 32, 33, 34, or 35. In any one or more embodiments of the alkoxylated fatty alcohol of formula (1), R⁴ is H.

In any one or more partitioning compositions of first embodiments, the one or more alkoxylated fatty alcohols comprise, consist essentially of, or consist of a first alkoxylated fatty alcohol comprising R¹ that is a linear or branched C16-C18 moiety; and a second alkoxylated fatty alcohol comprising R¹ that is a linear or branched C11-C14 moiety. In embodiments, the weight proportion of the first alkoxylated fatty alcohol to the second alkoxylated fatty alcohol in the partitioning composition is 3:1 to 1:3, for example 3:1 to 2:1, 2:1 to 1:1, 1:1 to 1:2, or 1:2 to 1:3.

In any one or more partitioning compositions of first embodiments, the one or more triglycerides are “actives” therein, and are present in the partitioning composition in a total amount of about 3 wt % to about 10 wt % based on the weight of the partitioning composition, for example 3 wt % to 4 wt %, 4 wt % to 5 wt %, 5 wt % to 6 wt %, 6 wt % to 7 wt %, 7 wt % to 8 wt %, 8 wt % to 9 wt %, or 9 wt % to 10 wt %. In any one or more partitioning compositions of first embodiments, each of the one or more triglycerides independently comprises, consists essentially of, or consists of a compound having a structure according to the formula (2)

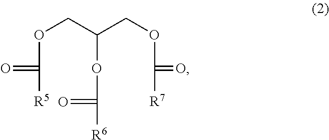

wherein R⁵, R⁶, and R⁷ of formula (2) are independently selected from saturated or unsaturated C10-C30 linear, branched, or alicyclic moieties. Accordingly, the one or more triglycerides are fatty acid triglycerides. In any one or more partitioning compositions of first embodiments, one or more of R⁵, R⁶, and R⁷ are C16-C20 moieties. In any one or more partitioning compositions of first embodiments, each of R⁵, R⁶, and R⁷ are C16-C20 moieties.

In any one or more partitioning compositions of first embodiments herein, one or more of R⁵, R⁶, and R⁷ of the triglyceride are linear. In any one or more partitioning compositions of first embodiments herein, each of R⁵, R⁶, and R⁷ are linear. In any one or more partitioning compositions of first embodiments herein, one or more of R⁵, R⁶, and R⁷ are unsaturated. In any one or more partitioning compositions of first embodiments herein, each of R⁵, R⁶, and R⁷ are unsaturated. In any one or more partitioning compositions of first embodiments herein, one or more of R⁵, R⁶, and R⁷ are monounsaturated. In any one or more partitioning compositions of first embodiments herein, one or more of R⁵, R⁶, and R⁷ include two or three unsaturated moieties.

In any one or more partitioning compositions of first embodiments herein, at least one of the one or more triglycerides is derived from a plant source. Suitable plant sources comprise, consist essentially of, or consist of whole plants, seeds, stems, flowers, roots, or two or more thereof from cotton, flax, grape, hemp, safflower, olive, palm, peanut, rice, avocado, canola, coconut, corn, sesame, soybean, sunflower, walnut, or any combination thereof. Each type of plant oil includes a characteristic blend of triglycerides, as well as one or more free fatty acids (that is, saturated or unsaturated C6-C30 linear, branched, or alicyclic carboxylic acids or a salt thereof) and in some cases diglycerides and monoglycerides of one or more fatty acids, either as part of the characteristic plant mixture, or as impurities including e.g. impurities arising from refining and/or processing thereof.

For example, as reported in “Corn oil, industrial and retail, all purpose salad or cooking, fat composition, 100 g”, (US National Nutrient Database, Release 28, United States Department of Agriculture; SR Legacy released April 2018) 100 g of corn oil includes a characteristic mixture of triglycerides, wherein the fatty acid moieties represented by R⁵, R⁶, and R⁷ of formula (2) correspond to about 12.9 g saturated fatty acid moieties, about 27.6 g monounsaturated fatty acid moieties, and about 54.7 g polyunsaturated fatty acid moieties. Additionally, about 99% of the unsaturated fatty acid moieties of a corn oil triglyceride are oleic acid moieties.

In any one or more partitioning compositions of first embodiments herein, the one or more fatty acids are “actives” therein, and are present in the partitioning composition in a total amount of about 55 wt % to about 65 wt % based on the weight of the partitioning composition, for example 55 wt % to 56 wt %, 56 wt % to 57 wt %, 57 wt % to 58 wt %, 58 wt % to 59 wt %, 59 wt % to 60 wt %, 61 wt % to 62 wt %, 62 wt % to 63 wt %, 63 wt % to 64 wt %, or 64 wt % to 65 wt %. In any one or more first embodiments herein, the one or more fatty acids comprise, consist essentially of, or consist of an aliphatic, linear or branched, saturated or unsaturated fatty (hydrocarbyl) group having 12 or more carbons bonded to a carboxylic acid group. In some first embodiments the fatty group has 12-50 carbons, or 12-40 carbons, or 12-30 carbons, or 12-20 carbons, or 14-50 carbons, or 14-40 carbons, or 14-30 carbons, or 14-28 carbons, or 14-26 carbons, or 14-24 carbons, or 14-22 carbons, or 16-50 carbons, or 16-40 carbons, or 16-30 carbons, or 16-28 carbons, or 16-26 carbons, or 16-24 carbons, or 16-22 carbons, or 16-20 carbons.

In any one or more embodiments herein, a fatty group of a fatty acid is aliphatic. In any one or more embodiments herein, a fatty group is linear or branched. In any one or more embodiments herein, a fatty group is saturated, or monounsaturated, or polyunsaturated (two or more unsaturated sites). In any one or more embodiments herein, any one or more unsaturated sites of a fatty group are independently configured as cis or trans. In any one or more embodiments herein, where a fatty hydrocarbyl group is polyunsaturated, the unsaturated sites are conjugated or unconjugated.

In any one or more first embodiments herein, the one or more fatty acids comprise, consist essentially of, or consist of a mixture of two more fatty acids, often three, four, five, or more fatty acids. In any one or more first embodiments herein the one or more fatty acids comprises, consists essentially of, or consists of a soy oil fatty acid (SOFA), a tall oil fatty acid (TOFA), oleic acid (OA), a soapstock fatty acid (SS), or any mixture of two or more of these, or another fatty acid mixture arising from the hydrolysis of plant- or animal-sourced triglycerides. SOFA and TOFA can vary compositionally within characteristic ranges depending on the individual plants and their growing environment. In any one or more partitioning compositions of first embodiments, the one or more fatty acids independently comprise, consist essentially of, or consist of natural mixtures thereof, such as soy oil fatty acid (SOFA), tall oil fatty acid (TOFA), a soapstock fatty acid (SS), as well as from fatty acid species such as stearic acid, palmitic acid, oleic acid, linoleic acid, linolenic acid, palmitoleic acid, 11-eicosenoic acid, erucic acid, and nervonic acid, and any combination thereof, including mixtures of natural fatty acid mixtures with one or more fatty acid species, either to increase the concentration of a specific fatty acid, or to provide a targeted combination of fatty acid species.

In any one or more partitioning compositions of first embodiments, the one or more fatty acid salts are “actives” therein, and are present in the partitioning composition in a total amount of about 10 wt % to about 20 wt % based on the weight of the partitioning composition, for example 10 wt % to 11 wt %, 11 wt % to 12 wt %, 12 wt % to 13 wt %, 13 wt % to 14 wt %, 14 wt % to 15 wt %, 15 wt % to 16 wt %, 16 wt % to 17 wt %, 17 wt % to 18 wt %, 18 wt % to 19 wt %, or 19 wt % to 20 wt %. In any one or more partitioning compositions of first embodiments, the one or more fatty acid salts independently comprise, consist essentially of, or consist of sodium, lithium, potassium, or ammonium salts of the conjugate bases of any of the fatty acids listed above, and mixtures of such salts.

Additionally, sodium, lithium, potassium, or ammonium salts of the conjugate bases of hydroxyacids are suitable fatty acid salts, and as such may be used alone or combined with one or more conjugate bases of the fatty acids listed above. Suitable hydroxyacid salts include salts of the conjugate bases of ricinoleic acid, 12-hydroxystearic acid, 9,10-dihydroxyoctadecanoic acid, 9,10,18-trihydroxyoctadecanoic acid, lesquerolic acid, 15-hydroxyhexadecanoic acid, isoricinoleic acid, densipolic acid, 14-hydroxy-eicosa-cis-11-cis-17-dienoic acid, 2-hydroxyoleic acid, 2-hydroxylinoleic acid, 18-hydroxystearic acid, 18-hydroxylinoleic acid, 15-hydroxylinoleic acid, or any mixture thereof. In any one or more partitioning compositions of first embodiments, a salt of a hydroxyacid is a product of hydrolysis of a natural oil. In some such embodiments, the natural oil is castor oil and the hydroxyacid salt includes a ricinoleate salt, such as sodium ricinoleate.

In any one or more partitioning compositions of first embodiments, the C11-C24 hydrotreated petroleum distillate is an “active” therein, and is present in the partitioning composition in a total amount of about 1 wt % to about 5 wt %, such as 1 wt % to 2 wt %, 2 wt % to 3 wt %, 3 wt % to 4 wt %, or 4 wt % to 5 wt %. The C11-C24 hydrotreated petroleum distillate is characterized as a “middle distillate”, a combination of products arising from fractional distillation of crude oil and having low (300 ppm or less) concentration of aromatic compounds. Such C11-C24 middle distillates are often used industrially as lubricants and metal working fluids. The C11-C24 hydrotreated petroleum distillate has a specific gravity between 0.81 g/ml and 0.84 g/ml; a flash point of 115°−120° C., as determined using ASTM D-93; and a boiling point ranging between 250° C. and 320° C. as determined using ASTM D-86. In any one or more partitioning compositions of first embodiments, the C11-C24 hydrotreated petroleum distillate is suitably characterized as having the lowest flash point of any component or compound mixture present in the partitioning compositions of first embodiments herein. Accordingly, the instant partitioning composition of first embodiments herein obtain the technical benefit of excluding the use of compounds having a flash point of less than 60° C., less than 70° C., less than 80° C., less than 90° C., less than 100° C., or less than 110° C.

In any one or more partitioning compositions of first embodiments, the partitioning composition further includes water, which functions as a solvent in the partitioning composition and is not considered an “active” component thereof. In any one or more partitioning compositions of first embodiments, water is present in an amount of about 10 wt % to about 20 wt %, for example 10 wt % to 11 wt %, 11 wt % to 12 wt %, 12 wt % to 13 wt %, 13 wt % to 14 wt %, 14 wt % to 15 wt %, 15 wt % to 16 wt %, 16 wt % to 17 wt %, 17 wt % to 18 wt %, 18 wt % to 19 wt %, or 19 wt % to 20 wt %. Accordingly, the partitioning compositions of first embodiments herein are suitably described as concentrates, wherein the partitioning composition concentrates include about 80 wt % to about 90 wt % actives (total) and about 10 wt % to about 20 wt % water.

In some first embodiments, a partitioning composition concentrate is diluted by mixing an additional amount of water with a partitioning composition concentrate to form a dilute partitioning composition including about 25 wt % to about 99.9 wt % water, such as 25 wt % to 30 wt %, 30 wt % to 35 wt %, 35 wt % to 40 wt %, 40 wt % to 45 wt %<45 wt % to 50 wt %, 50 wt % to 55 wt %, 55 wt % to 60 wt %, 60 wt % to 65 wt %, 65 wt % to 70 wt %, 70 wt % to 75 wt %, 75 wt % to 80 wt %, 80 wt % to 85 wt %, 85 wt % to 90 wt %, 90 wt % to 95 wt %, 95 wt % to 99 wt %, or 99 wt % to 99.9 wt % water, wherein the balance of the dilute partitioning composition (0.1 wt % to 75 wt %) is the partitioning composition actives.

Any one or more partitioning compositions of first embodiments herein suitably exclude a base, or basic compound, selected from sodium carbonate, potassium carbonate, sodium bicarbonate, potassium bicarbonate, sodium hydroxide, potassium hydroxide, ammonium hydroxide, or any combination thereof. In other embodiments, the partitioning composition of first embodiments further include a base. In such embodiments, the amount of base included in the partitioning compounds is selected to achieve homogeneity and/or solubility of the collective components of the partitioning composition. In embodiments, the amount of base added to a partitioning composition is about 0.01 wt % to about 3 wt % based on the weight of the partitioning composition, for example 0.01 wt % to 0.05 wt %, 0.05 wt % to 0.1 wt %, 0.1 wt % to 0.5 wt %, 0.5 wt % to 1.0 wt %, 1 wt % to 1.5 wt %, 1.5 wt % to 2.0 wt %, 2.0 wt % to 2.5 wt %, or 2.5 wt % to 3.0 wt % based on the weight of the partitioning composition.

Any one or more partitioning composition concentrates of first embodiments herein are formed by admixing the components thereof in the proportions recited herein, in any order. Dilute partitioning compositions are formed by first forming a partitioning composition concentrate, then diluting the concentrate with water. In any one or more first embodiments herein, a method of forming a partitioning composition comprises, consists essentially of, or consists of combining
one or more alkoxylated fatty alcohols,
one or more triglycerides,
one or more fatty acids,
one or more fatty acid salts,
a C11-C24 hydrotreated petroleum distillate, and
water.

Accordingly, in embodiments, the combining excludes a base: that is, forming the partitioning composition excludes further combining a compound such as sodium hydroxide, potassium hydroxide, sodium carbonate (soda ash) with the one or more alkoxylated fatty alcohols, one or more triglycerides, one or more fatty acids, one or more fatty acid salts, C11-C24 hydrotreated petroleum distillate, water, or any combination thereof.

The partitioning compositions of first embodiments herein, both concentrated and diluted, are characterized as having a homogeneous appearance wherein the components of the partitioning composition are mutually compatible and are dissolved or dispersed in the liquid water present therein. Accordingly, both the partitioning composition concentrates and the dilute partitioning compositions having the active components disclosed herein above, in the recited weight proportions relative to each other, are stable, homogeneous liquid compositions that do not undergo bulk phase separation when stored in a sealed containment for at least 3 days and up to 10 years at temperatures between 15° C. and 30° C.

Any of the partitioning compositions of first embodiments herein are suitably added to a mineral ore slurry to form a sparge composition, as described in second embodiments herein. Any one or more partitioning compositions of first embodiments herein are used to obtain froth flotation of a mineral ore employing methods described in third embodiments herein.

### Second Embodiments

Disclosed in second embodiments herein are sparge compositions comprising, consisting essentially of, or consisting of a medium comprising water; a mineral ore comprising a beneficiary and a gangue; and a partitioning composition of any of first embodiments above.

In any one or more sparge compositions of second embodiments, the medium comprising water is a liquid medium comprising, consisting essentially of, or consisting of fresh water, sea water, brackish water, tap water, water obtained from a creek, river, or pond, including sedimentation pond; runoff water, industrial waste water, water diverted from or obtained from a water treatment facility, or any combination thereof. The medium comprising water is present in a sparge composition of any one or more second embodiments in an amount of 30% to 80% by volume based on the weight of the ore, for example about 30% to 50%, or even about 60% to 80% by volume based on the weight of the ore.

In any one or more sparge compositions of second embodiments, the mineral ore is a solid material mined from one or more subterranean excavations and comprising, consisting essentially of, or consisting of a beneficiary and a gangue. In any one or more sparge compositions of second embodiments, the mineral ore comprises, consists essentially of, or consists of a phosphate ore. In any one or more sparge compositions of second embodiments herein, the amount of a mineral ore in a sparge composition is about 1% to about 80%, in embodiments about 10% to about 50%, or about 20% to about 45%, or even about 20% to about 30% by weight of the sparge composition.

As used herein, “phosphate ore” means a mineral ore that comprises a beneficiary comprising a phosphate group and/or phosphate moiety. As used herein, “phosphate” refers to a material comprising a phosphoric acid moiety or a salt thereof comprising PO₄³⁻, HPO₄²⁻, H₂PO₄, or any combination thereof as specified or determined by context herein. Accordingly, a phosphate beneficiary is a beneficiary comprising a phosphate group and/or phosphate moiety. In embodiments, a phosphate ore comprises or consists essentially a combination of one or more of Ca²⁺, PO₄³⁻, F⁻, OH⁻, CO₃²⁻, silica and/or silicate. In embodiments, a phosphate ore comprises a gangue comprising one or more carbonate anions, one or more silicate anions, more or more silicas, or any combination thereof. In embodiments, a phosphate ore comprises a gangue comprising calcite, dolomite, a silicate, silica, or any combination thereof. In embodiments, a phosphate beneficiary comprises, consists of, or consists essentially of Ca²⁺ and PO₄³⁻. In embodiments, a phosphate ore comprises an apatite, such as fluorapatite, hydroxyapatite, chlorapatite, or any combination thereof. In embodiments, the phosphate ore gangue comprises calcite, dolomite, a silicate, silica, a seashell or seashell portion, or any combination thereof.

In any one or more sparge compositions of second embodiments, the mineral ore is comminuted and/or classified prior to contacting the remaining components of the sparge composition to the ore. A comminuted mineral ore is a mined ore that is crushed, ground, or milled to obtain a reduced range of ore particle sizes. A classified mineral ore is a mined or comminuted ore that is partitioned in accordance with particle size, for example by screens or by hydrocyclone. In some such embodiments, a comminuted and/or classified ore, such as a comminuted and/or classified phosphate ore, has a particle size as measured by ASTM C136 of 90% less than 4000 microns (#4 US standard mesh), in embodiments about 90% less than 1500 microns, in embodiments 90% less than 1000 microns, in embodiments 90% less than 500 microns, or in embodiments 90% less than 250 microns as measured by ASTM C136.

In any one or more sparge compositions of second embodiments, about 80% to about 95% by weight of a comminuted and/or classified mineral ore has a particle size as measured by ASTM C136 from about 100 microns to about 700 microns. In some such embodiments, one or more of the following is true: about 40% to about 60% by weight of the comminuted and/or classified mineral ore has a particle size from about 105 microns to about 250 microns as measured by ASTM C136; about 15% to about 30% by weight of the comminuted and/or classified mineral ore has a particle size from about 250 microns to about 300 microns as measured by ASTM C136; about 10% to about 25% by weight of the comminuted and/or classified mineral ore has a particle size from about 300 microns to about 700 microns as measured by ASTM C136; no more than about 15% by weight of the comminuted and/or classified mineral ore has a particle size greater than about 700 microns as measured by ASTM C136; no more than about 5% by weight of the comminuted and/or classified mineral ore has a particle size less than about 105 microns as measured by ASTM C136.

In any one or more second embodiments herein, the weight proportion of the mineral ore to the partitioning composition actives in the sparge composition is about 10,000:1 to 10:1, for example 10,000:1 to 5,000:1, or 5,000:1 to 4,000:1, or 4,000:1 to 3,000:1, or 3,000:1 to 2,000:1, or 2,000:1 to 1,000:1, or 1,000:1 to 900:1, or 900:1 to 800:1, or 800:1 to 700:1, or 700:1 to 600:1, or 600:1 to 500:1, or 500:1 to 400:1, or 400:1 to 300:1, or 300:1 to 200:1, or 200:1 to 100:1, or 100:1 to 50:1, or 50:1 to 10:1 by weight of the mineral ore to the partitioning composition in the sparge composition. In embodiments, a sparge composition of second embodiments herein includes about 0.01 kg to about 10 kg per metric ton of mineral ore in the sparge composition, such as 0.01 kg/t to 0.10 kg/t, 0.10 kg/t to 0.30 kg/t, 0.30 kg/t to 0.50 kg/t, 0.50 kg/t to 0.70 kg/t, 0.70 kg/t to 1.00 kg/t, 1.00 kg/t to 1.30 kg/t, 1.30 kg/t to 1.50 kg/t, 1.50 kg/t to 1.70 kg/t, 1.70 kg/t to 2.00 kg/t, 2.00 kg/t to 2.50 kg/t, 2.50 kg/t to 3.00 kg/t, 3.00 kg/t to 3.50 kg/t, 3.50 kg/t to 3.50 kg/t, 4.00 kg/t to 4.50 kg/t, 4.50 kg/t to 5.00 kg/t, 5.00 kg/t to 5.50 kg/t, 5.50 kg/t to 6.00 kg/t, 6.00 kg/t to 6.50 kg/t, 6.50 kg/t to 7.00 kg/t, 7.00 kg/t to 7.50 kg/t, 0.10 kg/t to 7.50 kg/t, 8.00 kg/t to 8.50 kg/t, 8.50 kg/t to 9.00 kg/t, 9.00 kg/t to 9.50 kg/t, or 9.50 kg/t to 10.00 kg/t of mineral ore in the sparge composition.

In some second embodiments herein, a sparge composition includes, or is present at a pH between 5 and 12. In any one or more second embodiments herein, the pH of the sparge composition is the pH obtained by mixing the mineral ore with the medium comprising water to form an ore slurry, wherein the pH of the ore slurry is not adjusted or changed prior to adding the partitioning composition to the ore slurry. For example, the pH of a phosphate ore slurry—that is, a phosphate ore combined with a medium comprising water—is often between 5.0 and 8.0, for example 5.0 to 7.5, 5.0 to 7.0, 5.0 to 6.5, 5.5 to 8.0, 5.5 to 7.5, 5.5 to 7.0, 5.5 to 6.5, 6.0 to 8.0, 6.0 to 7.5, 6.0 to 7.0, often about 6.5. The partitioning compositions of first embodiments herein are suitably combined with a mineral ore slurry at whatever pH is obtained by slurry upon combining the mineral ore with the medium comprising water, to provide a sparge composition suitable for sparging.

Accordingly, the sparge compositions described herein can comprise an ore, an aqueous medium, and a partitioning composition of first embodiments herein; and advantageously can consist essentially of or even consist of an ore, an aqueous medium, and a partitioning composition of first embodiments herein. Any one or more sparge compositions of second embodiments herein are used to carry out froth flotation employing methods described in third embodiments herein.

### Third Embodiments

Disclosed in third embodiments herein are methods of froth flotation comprising, consisting essentially of, or consisting of forming a sparge composition of any of second embodiments above; and sparging the sparge composition to form a sparged composition, the sparged composition having an overflow and an underflow. Accordingly, in any one or more methods of third embodiments herein, a method of froth flotation comprises, consists essentially of, or consists of combining a mineral ore comprising a beneficiary and a gangue with a medium comprising water and a partitioning composition of any of first embodiments herein to form a sparge composition in accordance with second embodiments herein; and sparging the sparge composition to yield a sparged composition comprising an overflow and an underflow. During and after the sparging, bubbles of gas migrate through the sparged composition to form layer of bubbles, or froth, at the liquid-air interface. The layer of bubbles is referred to herein as the overflow.

In any one or more methods of third embodiments, the mineral ore is a phosphate ore. In any one or more methods of third embodiments herein, the method excludes adding a pH adjustment agent to the mineral ore, or to the ore slurry formed by combining the mineral ore with the medium comprising water, or to the sparge composition. In any one or more methods of third embodiments herein, the method excludes adding any additional solids or liquids to the mineral ore except the medium comprising water and a partitioning composition of first embodiments.

In any one or more methods of third embodiments, the method excludes adding pH adjustment agents, frothers, collectors, modifiers, depressants, or activators to the mineral ore, or to the ore slurry, or to the sparge composition, except where the pH adjustment agent(s), frother(s), collector(s), modifier(s), depressant(s), or activator(s) are added to an ore slurry as a component of a partitioning composition of first embodiments herein. For example, in any one or more third embodiments, the methods exclude adding pH adjustment agents to the mineral ore, or to the ore slurry, or to the sparge composition, except where the pH adjustment agent is added to an ore slurry as part of a partitioning composition of first embodiments herein. Conventional pH adjustment agents for use in conventional froth flotation include sodium hydroxide, potassium hydroxide, sodium carbonate (soda ash), hydrochloric acid, sulfuric acid, ammonium sulfate, ammonium hydroxide, acetic acid, oxalic acid, trifluoroacetic acid, nitric acid, and other strong Lewis acids and bases. Accordingly, it is an advantage of the methods of third embodiments that by using a partitioning composition of first embodiments to form a sparge composition, no pH adjustment agents are added to the mineral ore, no pH adjustment of the ore slurry is needed; and no pH adjustment of the sparge composition is needed between addition of the partitioning composition and sparging the sparge composition.

In another example, in any one or more third embodiments, the methods exclude adding a collector to the mineral ore, or to the ore slurry, or to the sparge composition, except where the collection agent or collector is added to an ore slurry as part of a partitioning composition of first embodiments herein. Collectors used in conventional froth flotation include any of the fatty acids or fatty acid salts listed above, including e.g. hydroxyacid salts. Conventionally, the most common collector used for direct flotation of phosphate ores is sodium oleate.

In yet another example, in any one or more third embodiments, the methods exclude adding modifier to the mineral ore, or to the ore slurry, or to the sparge composition, except where the modifier is added to an ore slurry as part of a partitioning composition of first embodiments herein. Modifiers used in conventional froth flotation are compounds observed to improve the performance of a collector or collection agent in a sparge composition, but are not collectors when used alone. Modifiers used in conventional froth flotation include diesel fuel, which has a flash point of 52° C. Other conventional modifiers include liquid petroleum fuels having flash points of less than 60° C. Other conventional modifiers include fuel oil, biodiesel, and other diesel fuel alternatives known to those of skill in the art of petroleum fuel compositions.

In yet another example, in any one or more third embodiments, the methods exclude adding a depressant to the mineral ore, or to the ore slurry, or to the sparge composition, except where the depressant is added to an ore slurry as part of a partitioning composition of first embodiments herein. Depressants used in conventional froth flotation include sodium silicate, starch, polysaccharides such as chitosan, and inorganic acids such as sulfuric acid or phosphoric acid. In yet another example, in any one or more third embodiments, the methods exclude adding a frother to the mineral ore, or to the ore slurry, or to the sparge composition. Frothers for use in conventional froth flotation include pine oil, eucalyptus oil, cresylic acid, and alkanols having C6 or greater. In yet another example, in any one or more third embodiments, the methods exclude adding an activator to the mineral ore, or to the ore slurry, or to the sparge composition. Activators for use in conventional froth flotation include inorganic sulfur-containing compounds such as copper sulfate and sodium sulfide.

Accordingly, in any one or more third methods herein, the method includes a single step between forming an ore slurry and sparging, which is addition of the partitioning composition to the ore slurry.

In any one or more methods of third embodiments herein, there is provided a method of sparging comprising: sparging any of the sparge compositions disclosed in second embodiments herein to yield a sparged composition. The sparged composition comprises an overflow and an underflow.

In any one or more methods of third embodiments herein, the sparging is carried out in a lab scale flotation cell. In any one or more methods of third embodiments herein, the method further includes collecting an overflow, collecting an underflow, or collecting both an overflow and an underflow, wherein the collecting comprises, consists essentially of, or consists of separating at least a portion of an overflow from at least a portion of an underflow arising from sparging a sparge composition of any of second embodiments herein and formed using any of the methods of third embodiments herein. Separating at least a portion of an overflow, from at least a portion of an underflow is accomplished using conventional methods known to those of skill in the art of froth flotation. In any one or more methods of third embodiments herein, such separating comprises, consists of, or consists essentially of: tapping off at least a portion of the overflow, skimming off at least a portion of the overflow, depositing at least a portion of the overflow onto a launder, decanting at least a portion of the overflow, or any combination thereof.

In any one or more methods of third embodiments herein, the overflow comprises a concentrate and a first portion of the medium; and the underflow comprises tailings and a second portion of the medium. The concentrate comprises, consists of, or consists essentially of the beneficiary. The tailings comprise, consist of, or consist essentially of the gangue. In any one or more methods of third embodiments herein where the mineral ore is a phosphate ore, the overflow includes a phosphate beneficiary, and the underflow includes a gangue comprising a silica, one or more silicates, and/or seashell particles.

In any one or more methods of third embodiments herein, the separating the at least the portion of the concentrate from the at least the portion of the tailings comprises, consists of, or consists essentially of separating at least a portion of the overflow from at least a portion of the underflow, wherein the overflow comprises concentrate and the underflow comprises tailings. In some such embodiments, the method comprises separating at least a portion of a froth layer from at least a portion of the underflow.

### Fourth Embodiments

Disclosed in fourth embodiments herein is the use of any one or more of the sparge compositions of second embodiments, which include a partitioning composition in accordance with any one or more first embodiments herein, to refine a mineral ore using froth flotation. In any one or more uses of fourth embodiments, the mineral ore is a phosphate ore; and the refined phosphate ore is used to produce phosphoric acid. In the phosphoric acid process, a phosphate ore and an acid such as sulfuric acid are combined and react together to produce phosphoric acid. The greater the proportion of gangue in the phosphate ore, the worse scaling problems and the like that can be encountered in the production of the phosphoric acid. Scaling, or scale buildup is a significant issue impacting the production rate of phosphoric acid. Froth flotation can be used to produce a concentrate comprising a higher percentage of the phosphate than in the raw phosphate ore, leading to increased ease of phosphoric acid manufacturing due to lower levels of impurities, and maintenance of good production rates due to reduced scaling.

We have found that in the uses of fourth embodiments, direct froth flotation of phosphate ores employing a partitioning composition of any one of first embodiments in any one or more sparge compositions of second embodiments herein, and sparging in accordance with any one or more of the methods of third embodiments herein, obtains about 1% to about 10% or greater recovery of phosphate (as P₂O₅) in a froth collected from the sparged composition, compared to a froth obtained by adding oleic acid and diesel to the same ore slurry instead of the partitioning composition, and in the same amount of total actives, followed adjusting the pH of the slurry prior to sparging, for example, at least 1.0%, at least 2.0%, at least 3.0%, at least 4.0%, at least 5%, at least 6%, at least 7%, at least 8%, at least 9%, at least 10%, or even greater than 10% higher recovery of phosphate (as P₂O₅) in froth collected from the partitioned sparge composition, compared to a froth obtained the foregoing two-step oleic acid-based partitioning. In any one or more fourth embodiments herein, the use of any one or more of the sparge compositions of second embodiments to refine a phosphate ore using froth flotation in accordance with the methods of third embodiments herein obtains a refined phosphate ore having both improved yield and improved grade of phosphate recovered when compared to the foregoing two-step oleic acid-based partitioning: adding oleic acid/diesel, followed by pH adjustment of the ore slurry. For example, in addition to the about 1% to about 10% or greater recovery of phosphate (as P₂O₅) in froth collected from the partitioned sparge composition, the froth obtained using the methods of third embodiments herein obtains about 0.1% to about 5.0% higher grade (purity) of recovered P₂O₅ compared to the foregoing oleic acid-based partitioning, that is, at least 0.1%, at least 0.2%, at least 0.3%, at least 0.4%, at least 0.5%, at least 0.6%, at least 0.7%, at least 0.8%, at least 0.9%, at least 1.0%, at least 2.0%, at least 3.0%, at least 4.0%, or at least 5.0% higher grade of recovered P₂O₅ compared to the foregoing two-step oleic acid-based partitioning.

We have also found that in the uses of fourth embodiments, direct froth flotation of phosphate ores employing a partitioning composition of any one of first embodiments in any one or more sparge compositions of second embodiments herein, and sparging in accordance with any one or more of the methods of third embodiments herein, obtains about 1% to about 10% or greater recovery of phosphate (as P₂O₅) in a froth collected from the sparged composition, compared to a froth obtained by adding sodium oleate and diesel to the same ore slurry instead of the partitioning composition, and in the same amount of total actives, for example, at least 1.0%, at least 2.0%, at least 3.0%, at least 4.0%, at least 5%, at least 6%, at least 7%, at least 8%, at least 9%, at least 10%, or even greater than 10% higher recovery of phosphate (as P₂O₅) in froth collected from the partitioned sparge composition, compared to a froth obtained using sodium oleate and diesel. In any one or more fourth embodiments herein, the use of any one or more of the sparge compositions of second embodiments to refine a phosphate ore using froth flotation in accordance with the methods of third embodiments herein obtains a refined phosphate ore having both improved yield and improved grade of phosphate recovered when compared to a froth obtained using sodium oleate and diesel. For example, in addition to the about 1% to about 10% or greater recovery of phosphate (as P₂O₅) in froth collected from the partitioned sparge composition, the froth obtained using the methods of third embodiments herein obtains about 0.1% to about 5.0% higher grade (purity) of recovered P₂O₅ compared to the foregoing oleic acid-based partitioning, that is, at least 0.1%, at least 0.2%, at least 0.3%, at least 0.4%, at least 0.5%, at least 0.6%, at least 0.7%, at least 0.8%, at least 0.9%, at least 1.0%, at least 2.0%, at least 3.0%, at least 4.0%, or at least 5.0% higher grade of recovered P₂O₅ compared to a froth obtained using sodium oleate and diesel.

### EXPERIMENTAL SECTION

### Control Example 1

As a control, the direct flotation of phosphate ore was carried out using oleic acid, a conventional collector for phosphate ores, wherein the pH of the phosphate ore slurry was adjusted to be between 8 and 11.

Flotation tests were conducted using a standard laboratory flotation test cell. An impeller situated within the cell, was set to stir at 600 rpm, and a phosphate ore sample was mixed with water in the test cell to form an ore slurry, or pulp, having solids between 65 wt % and 70 wt %. Oleic acid collector was added to the ore slurry in the amount of 0.44 kg per metric ton of the ore, along with 0.18 kg of a diesel fuel per metric ton of the ore; then soda ash was added with stirring to obtain pH of between 8.0 and 11 (approximately 0.13 kg per metric ton of ore). This mixture was stirred for 1.5 to 2 minutes at 600 rpm (“conditioning”). Then water was added to the flotation cell to obtain 25 wt % to 35 wt % solids concentration and the impeller was set to 1200 RPM. The contents of the test cell were sparged, and a froth was collected from the surface of the liquid in the cell at regular intervals for 1 to 2 minutes. Finally, the liquid slurry remaining in the test cell was collected as a single batch, after all the froth was collected. The froth and remaining liquid slurry were separately dried, weighed, and analyzed to determine weight percent phosphate (as P₂O₅) obtained in the froth (that is, grade), and weight percent phosphate recovered (as P₂O₅) from the phosphate ore. Results of the analysis are shown in Table 2.

### Control Example 2

The procedure of Control Example 1 was repeated, except that a pre-neutralized oleic acid was added to the ore slurry instead of oleic acid, and no soda ash or other pH adjustment agents were added to the ore slurry prior to sparging. The pre-neutralized oleic acid was prepared as a 5% solution by adding oleic acid to a 1.6 wt % soda ash solution. Then the pre-saponified oleic acid was added to the ore slurry in the amount of 0.44 kg per metric ton of the ore, along with 0.18 kg of diesel fuel per metric ton of the ore, followed by stirring for 1.5 to 2 minutes at 600 rpm, prior to sparging. Then water was added to the flotation cell to obtain 25 wt % to 35 wt % solids concentration and the impeller was set to 1200 RPM

. The contents of the test cell were sparged, and a froth was collected from the surface of the liquid in the cell at regular intervals for 1 to 2 minutes. Finally, the liquid slurry remaining in the test cell was collected as a single batch, after all the froth was collected. The froth and remaining liquid slurry were separately dried, weighed, and analyzed to determine weight percent phosphate (as P₂O₅) obtained in the froth (that is, grade), and weight percent phosphate recovered (as P₂O₅) from the phosphate ore. Results of the analysis are shown in Table 2.

### Control Example 3

The procedure of Control Example 2 was repeated, except that an oleic acid was added to the ore slurry instead of pre-neutralized oleic acid, and no soda ash or other pH adjustment agents were added to the ore slurry prior to sparging. The oleic acid was added to the ore slurry in the amount of 0.44 kg per metric ton of the ore, along with 0.18 kg of diesel fuel per metric ton of the ore, followed by stirring for 1.5 to 2 minutes at 600 rpm, prior to sparging. The contents of the test cell were sparged, the impeller was set to 1200 RPM. and a froth was collected from the surface of the liquid in the cell at regular intervals for 1 to 2 minutes. Finally, the liquid slurry remaining in the test cell was collected as a single batch, after all the froth was collected.

After sparging the contents of the test cell, no foam was collected at the slurry surface. Accordingly, no froth or liquid was collected or analyzed.

### Examples

Two partitioning compositions (Composition 1 and Composition 2) were prepared by admixing the components as shown in Table 1. Then both Composition 1 and Composition 2 were diluted with water to 5 wt % actives prior to further use. Composition 1 and Composition 2 were observed to be homogeneous in both concentrated and dilute form.

TABLE 1
Components and amounts thereof in
Composition 1 and Composition 2.

Amount, wt %

| | Compo- | Compo- |
|---|---|---|
| Component | sition 1 | sition 2 |
| Corn oil | 5.00 | 5.00 |
| Ethoxylated propoxylated C11-C14 alkanol | 1.00 | 1.00 |
| Ethoxylated propoxylated C16-C18 alkanol | 2.00 | 2.00 |
| C11-C24 hydrotreated petroleum distillate | 2.00 | 2.00 |
| Soy oil fatty acids (mixture) | 20.0 | 19.0 |
| Oleic acid | 27.7 | 40.0 |
| Linoleic acid | 8.19 | — |
| Palmitic acid | 2.52 | — |
| Linolenic acid | 2.10 | — |
| Stearic acid | 1.47 | — |
| Sodium 12-hydroxyoleate | 13.0 | 0.20 |
| Sodium palmitate | 0.21 | — |
| Sodium oleate | 0.56 | 0.52 |
| Sodium stearate | 0.21 | 0.20 |
| Sodium hydroxide | — | 2.50 |
| Water | 14.0 | 15.5 |

The procedure of Control Example 1 was repeated, adding either Composition 1 or Composition 2 to the ore slurry instead of oleic acid; and no soda ash or other pH adjustment agents or diesel were added to the ore slurry. Composition 1 and Composition 2 were both added in an amount of 0.44 kg actives per metric ton of ore.

For both Example 1 and Composition 2, the collected froth and remaining liquid slurry were separately dried, weighed, and analyzed to determine weight percent phosphate (as P₂O₅) obtained the concentrate (froth), and percent phosphate recovery (as P₂O₅). Results of the analysis are shown in Table 2.

TABLE 2
Weight percent phosphate (as P₂O₅) obtained the concentrate (froth),
and percent phosphate recovery (as P₂O₅) for Control Examples
1 and 2 and Composition 1 and Composition 2 of the Example.

| Experiment | Grade, P₂O₅ % | Recovery, % P₂O₅ |
|---|---|---|
| Control Example 1 | 28.67 | 87.79 |
| Control Example 2 | 29.39 | 88.84 |
| Control Example 3 | NA | NA |
| Composition 1 | 29.62 | 92.84 |
| Composition 2 | 29.54 | 92.37 |

As can be seen from inspection of Table 2, both Composition 1 and Composition 2 obtained significantly improved percent recovery of P₂O₅ compared to Control Example 1, employing oleic acid and diesel modifier, with pH adjustment of the slurry: Composition 1 obtained 5.1% higher recovery, and Composition 2 obtained 5.2% higher recovery. Composition 1 and Composition 2 also obtained a higher grade (purity) P₂O₅ compared to Control Example 1: Composition 1 obtained 3.3% higher grade of recovered P₂O₅, and Composition 2 obtained 3.0% higher grade of recovered P₂O₅.

As can be seen from inspection of Table 2, both Composition 1 and Composition 2 also obtained significantly improved percent recovery of P₂O₅ compared to Control Example 2, employing sodium oleate (pre-neutralized oleic acid) and diesel modifier: Composition 1 obtained 4.5% higher recovery, and Composition 2 obtained 4.0% higher recovery. Composition 1 and Composition 2 also obtained a higher grade (purity) P₂O₅ than Control Example 1: Composition 1 obtained 0.8% higher grade of recovered P₂O₅, and Composition 2 obtained 0.5% higher grade of recovered P₂O₅.

What is claimed:

1. A partitioning composition comprising a mixture of water and actives, wherein the actives comprise:
one or more alkoxylated fatty alcohols,
one or more triglycerides,
one or more fatty acids,
one or more fatty acid salts, and
a C11 to C24 hydrotreated petroleum distillate,
wherein the partitioning composition excludes a base.

2. The partitioning composition of claim 1 wherein each of the one or more alkoxylated fatty alcohols independently has a structure according to the formula 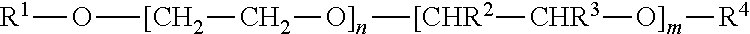
wherein
R¹ is a linear, branched, or alicyclic C6-C30 saturated or unsaturated moiety,
R² and R³ are independently selected from H or a C₁-C₅ linear or branched alkyl moiety,
R⁴ is H or CH₃, and
m and n are independently selected to be an integer between 5 and 50.

3. The partitioning composition of claim 2 wherein the one or more alkoxylated fatty alcohols comprises a first alkoxylated fatty alcohol comprising R¹ that is a linear or branched C16-C18 moiety; and a second alkoxylated fatty alcohol comprising R¹ that is a linear or branched C11-C14 moiety.

4. The partitioning composition of claim 3 wherein the proportion of the first alkoxylated fatty alcohol to the second alkoxylated fatty alcohol is between 3:1 and 1:3 by weight.

5. The partitioning composition of claim 3 wherein the first alkoxylated fatty alcohol and the second alkoxylated fatty alcohol both comprise R² that is H, R³ that is CH₃, n that is between 5 and 35, and m that is between 5 and 35.

6. The partitioning composition of claim 1 wherein each of the one or more triglycerides independently has a structure according to the formula 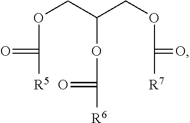
wherein R⁵, R⁶, and R⁷ are independently selected from saturated or unsaturated C16-C30 linear, branched, or alicyclic hydrocarbyl moieties.

7. The partitioning composition of claim 6 wherein R⁵, R⁶, and R⁷ are independently selected from saturated or unsaturated C16-C20 linear or branched hydrocarbyl moieties.

8. The partitioning composition of claim 1 wherein each of the one or more triglycerides are derived from a plant source selected from: cotton, flax, grape, hemp, safflower, olive, palm, peanut, rice, avocado, canola, coconut, corn, sesame, soybean, sunflower, walnut, or any combination thereof.

9. The partitioning composition of claim 1 wherein the one or more fatty acids comprise soy fatty acids, tall oil fatty acids, stearic acid, palmitic acid, oleic acid, linoleic acid, linolenic acid, palmitoleic acid, 11-eicosenoic acid, erucic acid, nervonic acid, or any combination thereof.

10. The partitioning composition of claim 1 wherein the one or more fatty acid salts comprise one or more sodium, lithium, potassium, or ammonium salts of the conjugate bases of one or more fatty acids and/or one or more hydroxyacids, wherein the one or more conjugate bases of one or more hydroxyacids comprise one or more conjugate bases of one or more of: ricinoleic acid, 12-hydroxystearic acid, 9,10-dihydroxyoctadecanoic acid, 9,10,18-trihydroxyoctadecanoic acid, lesquerolic acid, 15-hydroxyhexadecanoic acid, isoricinoleic acid, densipolic acid, 14-hydroxy-eicosa-cis-11-cis-17-dienoic acid, 2-hydroxyoleic acid, 2-hydroxylinoleic acid, 18-hydroxystearic acid, 18-hydroxylinoleic acid, 15-hydroxylinoleic acid, or any combination thereof.

11. The partitioning composition of claim 1 comprising:
about 3 wt % to about 10 wt % of the one or more triglycerides,
about 1 wt % to about 10 wt % of the one or more alkoxylated fatty alcohols,
about 55 wt % to about 65 wt % of the one or more fatty acids,
about 10 wt % to about 20 wt % of the one or more fatty acid salts,
about 1 wt % to about 5 wt % of the C11-C24 hydrotreated petroleum distillate, and
about 10 wt % to about 20 wt % water.

12. The partitioning composition of claim 1, wherein the partitioning composition excludes compounds having a flash point of less than 60° C.

13. The partitioning composition of claim 1 further comprising sodium carbonate, potassium carbonate, sodium bicarbonate, potassium bicarbonate, sodium hydroxide, potassium hydroxide, or any combination thereof.

14. A sparge composition comprising a mixture of:
(i) a medium comprising water;
(ii) a mineral ore comprising a beneficiary and a gangue; and
(iii) a partition composition in accordance with claim 1,
wherein the sparge composition excludes a base.

15. The sparge composition of claim 14 wherein the mineral ore is a phosphate ore, and/or the beneficiary comprises an apatite selected from the group consisting of fluorapatite, hydroxyapatite, chlorapatite, or any combination thereof; and/or the gangue comprises calcite, dolomite, a silicate, silica, a seashell or seashell portion, or any combination thereof.

16. The sparge composition of claim 14 wherein the partition composition actives are present in the sparge composition in an amount of about 0.01 kg to about 10 kg per metric ton of mineral ore in the sparge composition.

17. A method of partitioning a phosphate ore, the method comprising:
a. combining a phosphate ore with an aqueous medium to form an ore slurry;
b. adding a partitioning composition in accordance with claim 1 to the ore slurry to form a sparge composition; and
c. sparging the sparge composition to form a sparged composition,
wherein the method excludes further adding pH adjustment agents, frothers, modifiers, collectors, depressants, or activators to the phosphate ore, the ore slurry, or the sparge composition.

18. The method of claim 17 wherein the method excludes further adding any solids or liquids to the ore slurry or to the sparge composition.

19. The method of claim 17 further comprising collecting a froth from the sparged composition.

20. The method of claim 19, wherein the froth obtains at least 4.0% higher recovery of phosphate (as P₂O₅) than a froth obtained by adding sodium oleate and diesel to the ore slurry instead of the partitioning composition; and/or the froth obtains at least 0.5% higher grade of phosphate (as P₂O₅) than a froth obtained by adding sodium oleate and diesel to the ore slurry instead of the partitioning composition.

21. A method of forming a partitioning composition, the method comprising combining
one or more alkoxylated fatty alcohols,
one or more triglycerides,
one or more fatty acids,
one or more fatty acid salts,
a C11-C24 hydrotreated petroleum distillate, and
water,
wherein the combining excludes a base.

22. The method of claim 21 wherein the combining further excludes compounds having a flash point of less than 60° C.
